(19) United States
(12) Patent Application Publication
(10) Pub. No.: US 2009/0156249 A1
(43) Pub. Date: Jun. 18, 2009

(54) DEVICES AND COMPUTER READABLE MEDIA FOR USE WITH DEVICES HAVING AUDIO OUTPUT WITHIN A SPATIALLY CONTROLLED OUTPUT BEAM

(76) Inventor: John Ruckart, Atlanta, GA (US)

Correspondence Address: AT&T Legal Department - WK;Attn: Patent Docketing, Room 2A-207, One AT&T Way, Bedminster, NJ, 07921, US

(21) Appl. No.: 11/955,386

(22) Filed: Dec. 12, 2007

(51) Int. Cl. H04M 1/00

(52) U.S. Cl. 455/550.1

(57) ABSTRACT

User devices including wireline phones, mobile phones, and digital audio players utilize a directional speaker system to produce audio output within a spatially controlled beam. The audio output may be heard when in a position to receive the beam but may otherwise be significantly less detectable so that a user may hear the audio while a bystander may not. The user device may employ various modes such as a private distant mode and a non-private distant mode where the audio is output within the beam when in the private distant mode but is dispersed in a conventional manner when in the non-private distant mode. The directional speaker system may produce the audio beam through various techniques such as a phased array of transducers, a flat panel transducer, or a waveguide.

### BACKGROUND

Embodiments relate to audio reproduction. More particularly, embodiments relate to devices that produce an audio output that is projected within a spatially controlled output beam.

Devices that produce audio, such as fixed line and mobile telephones, digital audio players, and the like, often have a built-in speaker system that projects the sound. A user of such a device may be at some distance away from the device so that the sound must project a significant distance. For example, the user may place a portable digital audio player on a desk, and the audio may be projected from the device rather than the user wearing a headset. As another example, a user may place a fixed line or mobile telephone in a speakerphone mode so that the audio is projected from the device rather than the user holding the device up to the user's ear.

While such projection of the audio may allow the user to be physically separated from the device, there are problems with projecting the audio in this manner. The device must utilize a significant amount of power to project the audio particularly because the audio energy disperses from the speaker in all outward directions, with much of the audio energy being wasted since the user is at a specific position from the device. Utilizing this amount of power is a significant drawback for portable devices that already have a limited battery life.

Other problems may also occur due to projection of the audio in this manner. For example, other individuals may be nearby and may wish not to hear the audio, but the dispersion of the audio energy in all outward directions from the device results in the audio being heard by most or all nearby individuals. The opposite situation is also a problem, where the user of the device prefers that the nearby individuals not hear the audio regardless of whether the nearby individuals want to hear the audio or not.

### SUMMARY

Embodiments address issues such as these and others by providing audio output from a device where the audio is projected within a spatially controlled output beam. Thus, the beam, and hence the far majority of the audio energy, may be directed toward the user while audio energy is not significantly dispersed in other directions. Those nearby are less likely the hear the audio while the total amount of power that is expended may be reduced since the beam may use less audio energy than if the audio energy was dispersed in all outward directions.

Embodiments provide a telecommunications device that includes a transmitter that sends communication signals and a receiver that receives communication signals. A microphone receives audio signals and converts the audio signals to electrical signals. A directional speaker system receives the electrical signals from the microphone and converts the electrical signals to audio signals that are projected within a spatially controlled output beam. A controller provides input to the transmitter based on the electrical signals from the microphone and provides a signal to the directional speaker system based on the communication signals received by the receiver.

Embodiments provide a personal audio device that includes a handheld housing and an input selector mounted to the handheld housing that receives user manipulation to select an audio source. A directional speaker system within the handheld housing receives electrical signals and converts the electrical signals to audio signals that are projected within a spatially controlled output beam that emanates from the handheld housing. A controller within the handheld housing provides an electrical signal to the directional speaker system based on the user selection of the audio source.

Embodiments also provide a computer readable medium for use in a personal audio device that includes a handheld housing, a sensor to produce an output based on an orientation of the handheld housing, and a directional speaker system within the handheld housing that receives electrical signals and converts them to audio signals that are projected within a spatially controlled output beam that emanates from the handheld housing. The computer readable medium contains instructions that perform acts comprising reading from the sensor to detect the orientation of the handheld housing. The acts further comprise providing an electrical signal to the directional speaker system, wherein the electrical signal dictates the direction of the spatially controlled output beam and is based on the detected orientation of the handheld housing.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows a user device producing a beam of audio according to various embodiments.

FIG. 2 shows a user device for producing a beam of audio that includes telecommunication features according to various embodiments.

FIG. 3 shows a user device for producing a beam of audio that detects orientation according to various embodiments.

FIG. 4 shows one example components of a user device that produces a beam of audio according to various embodiments.

FIG. 5 shows another example of components of a user device that produces a beam of audio according to various embodiments.

FIG. 6 shows another example of components of a user device that produces a beam of audio according to various embodiments.

FIG. 7 shows an example of logical operations performed by a user device that produces a beam of audio according to various embodiments.

### DETAILED DESCRIPTION

According to exemplary embodiments, user devices, such as fixed line and mobile phones, personal digital assistants, digital music players, and the like. produce a beam of audio output through one of various techniques. The beam of audio output may provide for increased privacy for the user, decreased annoyance of bystanders, and potentially reduced power consumption by the device.

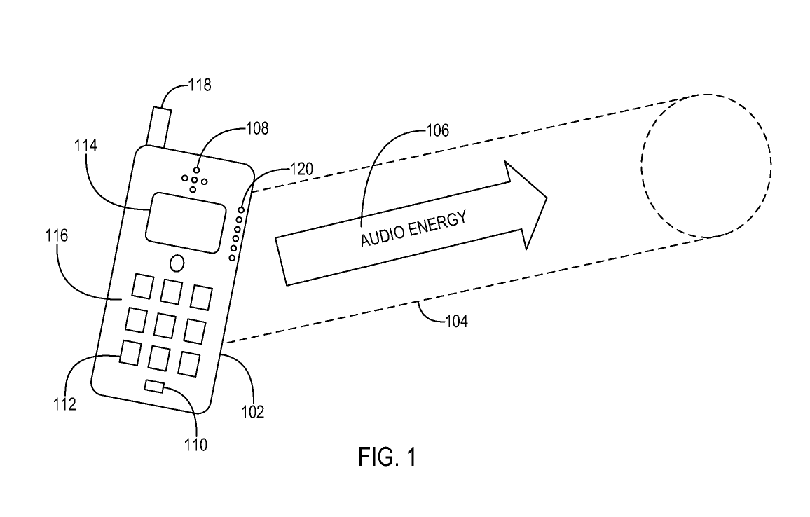

FIG. 1 shows an example of a user device 102. This user device 102 is an audio source for a user. The audio may be for a telephone call, music, and so forth. Accordingly, the user device 102 may be a telecommunications device, such as a fixed line phone including personal handsets, conference phones, and cordless phones with a fixed line base. The user device 102 may be other telecommunications devices, including mobile phones using technologies such as cellular, Wi-Fi, Wi-Max, and the like. This user device 102 may alternatively be an audio device that lacks telecommunications abilities, such as a dedicated digital audio player, a fixed or portable radio, or other dedicated audio source.

Regardless of the form which the user device 102 takes, the user device 102 includes an audio output 120 from which a spatially controlled beam 104 is produced that includes audio energy 106. The audio output 120 may be positioned at any location on the user device 102 that is suitable for outputting the beam 104 to a position where the user, and particularly one or more ears of the user, is located. As shown, the audio energy 106 is contained within the beam 104 such that the audio energy 106 is not being dispersed in all outward directions form the user device 102. Instead, the audio energy 106 is directed within the beam 104 to a particular location/position, and so long as one or more ears of the user are present at this position/location, the user can hear the audio from the user device 102. Those individuals not present at the particular position or location receive little or no audio energy from the user device 102.

An exemplary range of sound wave spread angles for embodiments disclosed herein is on the order of 15 degrees or less, whereas a conventional cone speaker projecting directly from the cellphone has a sound wave spread angle on the order of 45 degrees or more. The distance to which the directional sound wave can project according to the exemplary embodiments disclosed herein can be dictated by the amount of power being used to drive the audio, which may be user selectable at the user device 102.

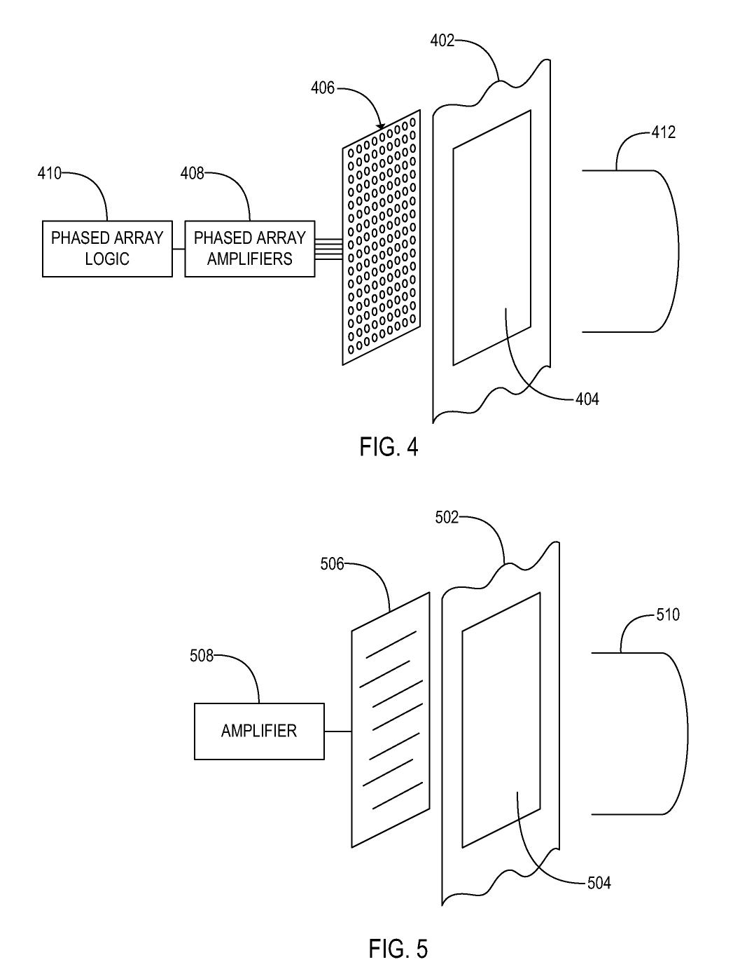

The user device 102 may have additional features used in conjunction with the audio output 120. A housing 116 may enclose the components of the user device 102. The housing 116 may be a handheld housing, as in the case of personal devices such as mobile phones, PDAs, and digital music players or may be a desktop housing, as in the case of a conference room telephone. The audio output 120 may provide an outlet through which the audio energy 106 escapes from the housing 116. Additional details regarding production of the beam 104 including the audio energy 106 and outputting of the beam 104 of audio energy 106 from the housing 116 are discussed below in relation to FIGS. 4-6.

The user device 102 may include additional audio output 108, such as where the user device 102 may be held in very close proximity to an ear of the user as with conventional phone handsets and mobile phones. In that case, the audio output 120 may be deactivated while the user is holding the audio output 108 in proximity to an ear, and then audio output 120 may be activated when the user device 102 is positioned at a distance, as in a speakerphone or hands-free mode.

The user device 102 may include an audio input 110, such as a microphone that picks up audio. The user device 102 may utilize an audio input 110 to provide recording functions or to provide the user with the ability to participate in voice communications, such as where the user device 102 is a telecommunications device.

The user device 102 may include manual inputs 116, such as a physical keypad, softbuttons on a display 114, and so forth. The display 114 may also provide visual output to the user, such menu options, information about music being played, information about a call in progress, and so forth.

The user device 102 may also include connectivity options, such as an antenna 118 or a plug for wired connections. An antenna 118 may be used to connect the user device 102 to a mobile communications network such as a cellular, Wi-Fi, Wi-Max, or other wireless connection such as to a cordless base to a fixed line phone connection.

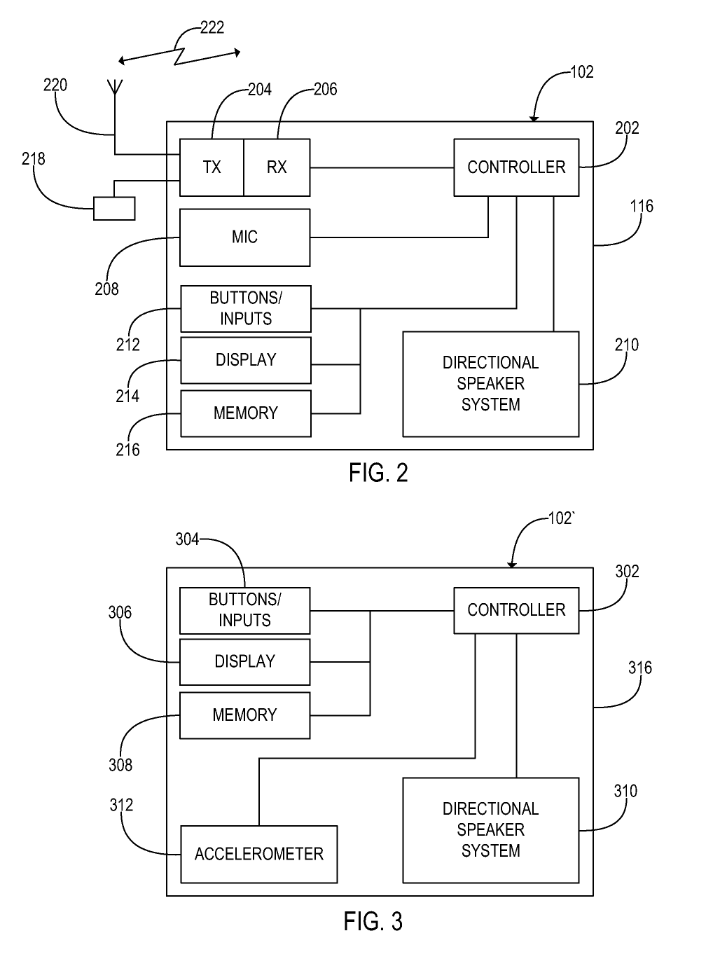

FIG. 2 shows one example of components of the user device 102. These components include telecommunications components as well as audio production components. A controller 202 performs processing tasks for the user device 102, such as to perform functions, receive various inputs, and produce various outputs. The controller 202 may be of various forms such as a general purpose programmable processor, an application specific processor, hard wired digital logic, or combinations thereof. The controller 202 may utilize a memory 216 to store programming, settings data, audio data such as music and alarms, and other information.

The controller 202, which may include embedded storage such as the memory 216, and/or separate memory 216 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

A transmitter 204 and receiver 206, which may be integrated as a transceiver, are included and communicate with the controller 202. The transmitter 204 and receiver 206 may be for wireless communications and utilize an antenna 220 to transfer wireless signals 222. Alternatively, the transmitter 204 and receiver 206 may be for wired communications and utilize a wireline connector 218, such as a conventional analog or digital phone line plug that may interface to a circuit switched public switched telephone network (PSTN) or other telephone network, e.g., a packet-switched network.

Inputs 212, such as the physical buttons of a keypad or softbuttons that are visually displayed, communicate with the controller 202 to indicate that user input is being provided. User input may be to place or answer a telephone call, as a selector for choosing a particular audio file or other audio source for playback, to use an audio output for a close proximity mode versus an audio output for a distance mode, and to use a privacy mode where the audio beam 104 is active versus a non-privacy mode where a conventional speakerphone output is produced when in the distance mode.

A display 214 provides visual information to the user. The visual information may indicate a mode of the audio output, such as whether the close proximity mode versus the distance mode is active, and whether the privacy mode versus the non-privacy mode is active when in the distance mode. The visual information may also specify other operating parameters of the user device 102 including call status, audio content information, and the like.

A microphone 208 may receive audio signals and convert the audio signals to electrical signals that are provided as audio inputs to the controller 202. The electrical signals from the microphone 208 may be recorded to memory 216 by the controller 202 when in a recording mode. Likewise, the electrical signals may be provided by the controller 202 to the transmitter 204 for transmission over a communication network during phone calls.

A directional speaker system 210 is also present to produce the audio beam 104 including audio energy 106. The controller 202 may send electrical signals representative of audio from memory 216, from the receiver 206, or from other audio sources to the directional speaker system 210. The controller 202 may allow the user to select audio for playback at the time of the selection or at some future time. For example, the controller 202 may allow the user to specify audio as a signal to be played and/or specify an event that triggers when a particular audio signal is to be provided for audio playback. For example, the user may specify a particular audio file to use as a ringer for an incoming phone call. Furthermore, the controller 202 may track alarm conditions such as appointment times or emergency conditions, and an alarm signal may be provided for audio playback in response to the alarm condition.

Where the controller 202 offers multiple modes, then the controller 202 activates the directional speaker system 210 accordingly. For example, the directional speaker system 210 may have the ability to produce normally or a beam 104 of audio. Furthermore, the directional speaker system 210 may have the ability to produce lower volume, close proximity mode audio. Thus, where the controller 202 offers close proximity versus distance modes, and offers private and non-private distanced modes, then the directional speaker system 210 may be capable of producing the audio for any of those modes in response to instruction from the controller 202.

As an alternative, the directional speaker system 210 may not be capable of producing the close proximity audio but may be capable of producing both a private distance mode audio and a non-private distance mode audio. In that case, then a close proximity audio system may also be included for the user device 102, such as a conventional handset speaker used in an earpiece.

As yet another alternative, the directional speaker system 210 may be capable of producing private distance mode audio but not close proximity audio or non-private distance mode audio. In that case, then a close proximity audio system and a non-private distance mode audio system may also be included for the user device 102. In some embodiments, one audio system may provide both the close proximity audio and the non-private distance audio by controlling the volume output. In other embodiments, one audio system may provide the close proximity audio while another audio system provides the non-private distance audio.

It will be appreciated that there are numerous ways for handling multiple modes of audio. It will also be appreciated that the controller 202 may allow for private distance audio only such that the directional speaker system 210 provides all of the audio output capability needed for the user device 102. It will also be appreciated that the controller 202 may also provide output through wired or wireless headsets when output via the directional speaker system 210 is not desired.

The audio may also be multi-channel, as in the case of stereo or surround sound music. According to illustrative embodiments, the directional speaker system 210 may have multi-channel audio capability which produces a separate beam 104 for each channel or grouping of channels, with each beam 104 having slightly different direction in order to separate the multiple channels in physical space. Thus, one beam 104 corresponding to a left channel may be directed in one direction while another beam 104 corresponding to a right channel may be directed in another. The user may position himself or herself so that the left ear receives predominantly the left channel beam 104 while the right ear receives predominantly the right channel beam 104.

FIG. 3 shows another example of a user device 102′. This user device 102′ lacks the telecommunications abilities of the previous example and may be a dedicated audio device such as a digital audio player where a controller 302 obtains audio data from memory 308 and provides it to a directional speaker system 310. The directional speaker system 310 then produces the audio output beam 104 including the audio energy 106. Other features may also be included such as inputs 304 and a display 308 for purposes such as those discussed above.

In this example, the user device 102′ also includes at least one accelerometer 312 or other orientation detecting component. The controller 302 communicates with the accelerometer 312 to obtain a signal that represents an orientation of the user device 102′. The orientation is whether the device is laying flat or at an angle and whether it is laying on its face, back, top, bottom or sides.

The controller 302 makes use of the orientation to instruct the directional speaker system 310. A direction of the beam 104 may be controllable in some embodiments. Thus, one orientation may call for one beam direction while another orientation may call for a different beam direction. Thus, the controller 302 may instruct the directional speaker system 310 to produce a particular beam direction to suit a current orientation and may request a change to the beam direction as the orientation of the user device 102′ changes.

As an example, the user device 102′ may be expected to project the beam at a particular angle relative to the horizontal. Thus, the location of the point at which the audio beam 104 is emitted may change as the orientation changes. Thus, the directional speaker system 310 may change the direction of the beam relative to the user device 102′ so that the beam remains as close to the specified angle to the horizontal as possible.

While the example of FIG. 3 shows the accelerometer 312 or other orientation sensing component being used in a user device 102′ that lacks communication abilities, it will be appreciated that an orientation sensing device may also be employed in a telecommunications equipped user device 102 as shown in FIG. 2. In that case, the controller 202 may be responsive to the orientation signal and the directional speaker system 210 may be capable of changing the beam direction as requested by the controller 202.

FIG. 4 shows one example of the components of a directional speaker system 210, 310 that may be used by a user device 102, 102′. A phased array logic 410 employs well-known signal processing for producing spatially controlled audio beams 412 from an array 406 of transducers of a given arrangement by altering the phase received by some of the transducers relative to that received by others. The phased array logic 410 sends audio signals for each of the transducers of the array 406 to a set of phased array amplifiers 408 that ultimately drive each of the transducers of the array 406. The array 406 may be made up of any number of transducers in various patterns. The transducers may be constructed of various materials such as ceramics, piezoelectrics, and the like.

The phased array logic 410 may be used to place all of the transducers in phase to produce a non-private distance mode or to use the phase differential to produce the beam 104 of the private distance mode. Furthermore, the phased array logic 410 may be used to direct the beam by altering which transducers are out of phase relative to the others in the array. To further assist in changing direction of the beam, the array 406 may have curvature or multiple planes for the transducers to enhance the range of directions possible for the beam 412. Furthermore, this same configuration may be employed to produce multiple beams 104 corresponding to multiple channels of audio.

The array 406 produces audio energy such that audio waves are combined and cancelled for areas outside of the audio beam 412 by altering the phase of the outer transducers relative to the inner ones. Furthermore, audio waves are combined and intensified within the beam 412 as the inner transducers remain in phase. This principle is the same as used for a Long Range Audio Device (LRAD) weapon and is discussed in detail in the article How LRAD works, by Tracy V. Wilson, which can be accessed from http://science.howstuffworks.com/lrad2.htm, the contents of which are incorporated herein by reference.

A housing 402 of the user device 102, 102′ includes an audio transparent area 404 through which the audio beam 412 escapes. This transparent area 404 may be one large aperture, a collection of many apertures, a screen, or other similar structure.

FIG. 5 shows another example of the components of a directional speaker system 210, 310 that may be used by a user device 102, 102′. An amplifier 508 receives the audio signal and then drives a metal flat panel transducer 506 that produces a non-dispersed audio output such as a spatially controlled beam 510, albeit the metal flat panel transducer 506 may not provide as narrow a beam 510 as the previous example. Examples of various types of flat panel transducers, including electrostatic, array based, and the like are discussed at http://www.usfps.com/faq.html#Qs%201.

In order to produce different directions for the beam 510, multiple metal flat panel transducers 506 may be present, each facing a different direction such that a particular metal flat panel transducer 506 becomes active when the beam 510 should be emitted in the direction that flat panel transducer 506 is facing. Furthermore, this same configuration may be employed to produce multiple beams 104 corresponding to multiple channels of audio.

A housing 502 of the user device 102, 102′ also includes an audio transparent area 504 though which the audio beam 510 escapes. As with the previous example, this transparent area 504 may be one large aperture, a collection of many apertures, a screen, or other similar structure.

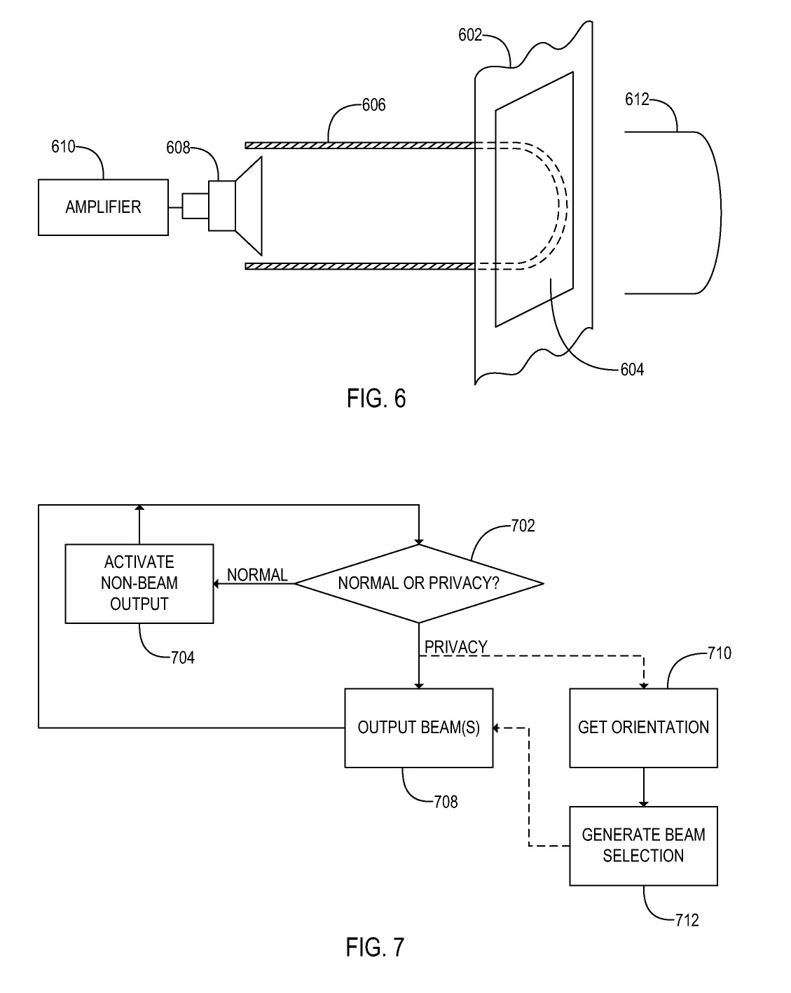

FIG. 6 shows another example of the components of a directional speaker system 210, 310 that may be used by a user device 102, 102′. An amplifier 610 drives a conventional speaker 608. The speaker 608 emits audio energy into a waveguide 606. The waveguide 606 is shown in cross-section for clarity. The waveguide 606 extends over a substantial length, for example several times the diameter of the speaker 608, before reaching a housing 602 and an audio transparent area 604. A spatially controlled audio beam 612 emerges from the waveguide 606, albeit possibly a less narrow beam 612 than that produced by the other examples discussed above. Discussion of using various examples of waveguides to control sound radiation can be found in U.S. Pat. No. 7,068,805.

Other manners of providing a directional speaker system 210, 310 are also contemplated. For example, techniques such as those used for digital light processing (DLP) televisions may also be used to produce very small scale audio production devices that may be employed within a user device 102, 102′ to produce spatially controlled audio beams.

FIG. 7 shows one example of a set of logical operations that may be performed by various embodiments when a distance mode of audio is desired. A controller 202, 302 detects whether a normal, i.e., non-privacy, mode or a privacy mode has been selected at a query operation 702. If normal, then the controller 202, 302 activates a non-beam audio output from the directional speaker system 210, 310 at an audio operation 704. As discussed above, this non-beam output may be produced by the same system that can produce the beam 104 or by a separate speaker system.

If the privacy mode has been selected, then the controller 202, 302 instructs the directional speaker system to begin outputting the audio beam 104 at an audio operation 708. For embodiment such as that of FIG. 3 where the orientation of the device is available, then the controller 202, 302 gets the orientation from the orientation sensor at an orientation operation 710. The controller 202, 302 then generates a beam selection instruction that is provided to the directional speaker system 210, 310 at a selection operation 712. The directional speaker system 210, 310 then generates the beam in the selected direction at the audio operation 708. The logical operations repeat to detect changes to the mode and/or the orientation of the user device 102, 102′.

Thus, as discussed above, a user device that produces audio may output audio as a beam 104 of audio energy 106 rather than dispersing the audio energy in all outward directions. The audio can be focused onto the user to maintain privacy and to avoid annoyance to bystanders.

While embodiments have been particularly shown and described, it will be understood by those skilled in the art that various other changes in the form and details may be made therein without departing from the spirit and scope of the invention.

What is claimed is:

1. A telecommunications device, comprising:
a transmitter that sends communication signals;
a receiver that receives communication signals;
a microphone that receives audio signals and converts the audio signals to electrical signals;
a directional speaker system that receives the electrical signals from the microphone and converts the electrical signals to audio signals that are projected within a spatially controlled output beam; and
a controller that provides input to the transmitter based on the electrical signals from the microphone and that provides a signal to the directional speaker system based on the communication signals received by the receiver.

2. The telecommunications device of claim 1, wherein the directional speaker system comprises a phased array of transducers that produces the spatially controlled output beam.

3. The telecommunications device of claim 1, wherein the directional speaker system comprises at least one flat panel transducer that produces the spatially controlled output beam.

4. The telecommunications device of claim 1, wherein the directional speaker comprises a waveguide that produces the spatially controlled output beam.

5. The telecommunications device of claim 1, wherein the controller provides a second signal to the directional speaker system based on detection by the controller of an event for which an audio output is specified.

6. The telecommunications device of claim 5, wherein the event is an alarm condition and wherein the second signal is an alarm signal.

7. The telecommunications device of claim 1, further comprising memory storing audio data, and wherein the controller provides a third signal to the directional speaker system based on the audio data.

8. The telecommunications device of claim 7, wherein the audio data corresponds to music.

9. The telecommunications device of claim 1, wherein the transmitter and receiver wirelessly communicate with a wireless network.

10. The telecommunications device of claim 1, wherein the transmitter and receiver communicate through a wireline with a public switched telephone network.

11. A personal audio device, comprising:
a handheld housing;
an input selector mounted to the handheld housing that receives user manipulation to select an audio source;
a directional speaker system within the handheld housing that receives electrical signals and converts the electrical signals to audio signals that are projected within a spatially controlled output beam that emanates from the handheld housing; and
a controller within the handheld housing that provides an electrical signal to the directional speaker system based on the user selection of the audio source.

12. The personal audio device of claim 11, wherein the input selector is a physical button.

13. The personal audio device of claim 11, wherein the input selector is a visual display of selectable options.

14. The personal audio device of claim 11, further comprising a memory storing audio data and wherein the controller provides a signal produced from the audio data upon the user selecting the audio source that corresponds to the audio data in the memory.

15. The personal audio device of claim 14, wherein the directional speaker system is a phased array.

16. The personal audio device of claim 15, wherein the audio data represents multiple channel audio and wherein the phased array produces the spatially controlled output beam to project at least a first channel of the multiple channel audio and produces a second spatially controlled output beam to project a second channel of the multiple channel audio.

17. The personal audio device of claim 11, further comprising a transmitter and receiver that communicate wirelessly with a wireless communication network.

18. A computer readable medium for use in a personal audio device that includes a handheld housing, a sensor to produce an output based on an orientation of the handheld housing, and a directional speaker system within the handheld housing that receives electrical signals and converts them to audio signals that are projected within a spatially controlled output beam that emanates from the handheld housing, the computer readable medium containing instructions that perform acts comprising:
reading from the sensor to detect the orientation of the handheld housing; and
providing an electrical signal to the directional speaker system, wherein the electrical signal dictates the direction of the spatially controlled output beam and is based on the detected orientation of the handheld housing.

19. The computer readable medium of claim 18, wherein the sensor comprises at least one accelerometer.

20. The computer readable medium of claim 18, wherein the personal audio device further includes a transmitter and receiver that communicate wirelessly with a wireless communication network, and wherein the acts further comprise directing signals to the directional speaker system based on communication signals received through the receiver.
